(19) United States
(12) Patent Application Publication
(10) Pub. No.: US 2007/0265132 A1
(43) Pub. Date: Nov. 15, 2007

(54) Transmission Device For an Auxiliary or Accessory of a Variable-Speed Engine, an Engine Equipped Therewith and Uses Thereof

(75) Inventor: Roumen Antonov, Paris (FR)

Correspondence Address: KENYON & KENYON LLP, ONE BROADWAY, NEW YORK, NY, 10004, US

(73) Assignee: ANTONOV AUTOMOTIVE TECHNOLOGIES B.V., CH Rotterdam, Pays-Bas (NL)

(21) Appl. No.: 11/663,709

(22) PCT Filed: Sep. 22, 2005
(86) PCT No.: PCT/FR05/02349

§ 371 Date: Mar. 23, 2007

(30) Foreign Application Priority Data
Sep. 23, 2004 (FR) 0410083

(51) Int. Cl. F16H 3/74; F16H 3/44

(52) U.S. Cl. 475/258; 475/269

(57) ABSTRACT

The invention concerns a transmission device (12) mounted between a supercharger compressor (7) and a pulley (11) designed to drive same from the vehicle motor. The device comprises two successive modules (16, 46) each capable of a direct engagement ratio through a free wheel (31, 61), or of an overdrive ratio by locking the planet gear (21, 51) by means of a clutch (26, 56) clamped by a spring (28) or released by the action of centrifugal counter-weights (32, 62) whereof the action is at least compensated by the axial thrust of the teeth Fₚ produced by the planet gear (21, 52) when it is loaded. The invention is useful for independently regulating the rotational speed of the apparatus (7) notwithstanding the speed variations of the pulley (11).

This invention relates to a transmission device with at least two ratios for driving an apparatus from a variable-speed engine, in particular for driving for example a supercharging compressor, an air-conditioning compressor, or also an electric machine, from an engine, typically a heat engine, of a motor vehicle.

This invention also relates to a supercharged heat engine equipped with a transmission device according to the invention.

This invention moreover relates to various uses of the transmission device according to the invention.

The apparatuses of the above-mentioned type are typically driven by a belt from the vehicle's engine shaft. The apparatus is therefore subjected to the variations in the vehicle engine's rotation speed. This type of apparatus often has a relatively narrow effective operating range, narrower than the range of a vehicle engine's rotation speed. It is therefore impossible with a single gear ratio between the drive engine and the apparatus, to ensure a constantly optimum operation of the apparatus.

Consequently, the gear ratio is usually chosen in order to take account, on the one hand, of the maximum rotation speed of the apparatus, which must not be exceeded, particularly when the engine is operating in the vicinity of its maximum rotation speed, and on the other hand, in order that the operating speed of the apparatus is optimum when the engine is operating at its most usual speed of rotation.

However, with such a setting, the apparatus often has a very reduced effectiveness when the engine is idling or operating at a very low speed. This is very disadvantageous in practice. For example, the need for air conditioning in a vehicle is greatest when its speed of travel is very low or zero. As a further example, for a heat engine to have a favourable characteristic curve of its engine torque as a function of its speed of rotation, it is generally desirable for the torque to be high. For a relatively low rotation speed. As regards an electric machine, it would be preferable to recharge the accumulator battery when the engine is idling, rather than take power from the engine for that purpose when said power is necessary to power the vehicle.

Transmission devices with several ratios have already been developed in order to overcome the above drawbacks. However, these transmissions devices are controlled by the electronics of the engine or even of the vehicle, on the basis of indications given by sensors. Moreover, electric or hydraulic actuators are necessary. As a whole, the known types of transmission devices are complex and their interconnection with the vehicle's electronic system is a potential source of complex breakdowns.

The object of this invention is to remedy these drawbacks and in particular to provide a transmission device which meets the requirements in an essentially autonomous manner.

According to the invention, the transmission device with at least two ratios to enable an apparatus to be driven by a variable-speed engine, such as a vehicle engine, comprising a selective coupling means capable of two states corresponding to a low gear ratio and to a high gear ratio in which the apparatus is driven at a higher speed than in the low gear ratio for a same rotation speed of the engine, is characterized in that said transmission device comprises at least one force-generating means in order to generate an actuating force that varies depending on at least one parameter chosen from a rotation speed and a torque in the device, and at least one urging means to apply the actuating force to the selective coupling means.

The invention also relates to various uses of the device according to the invention, for driving a supercharging compressor of the engine, for driving a motor vehicle's air-conditioning compressor from the motor vehicle's propulsion engine, or also for the link between an electric machine and a motor vehicle's propulsion engine.

Moreover, the invention relates to a heat engine equipped with a supercharging compressor, characterized in that the supercharging compressor is driven by the engine shaft via a transmission device according to the invention.

Other features and advantages of the invention will also become apparent from the following description, which relates to non-limitative examples.

In the attached drawings:

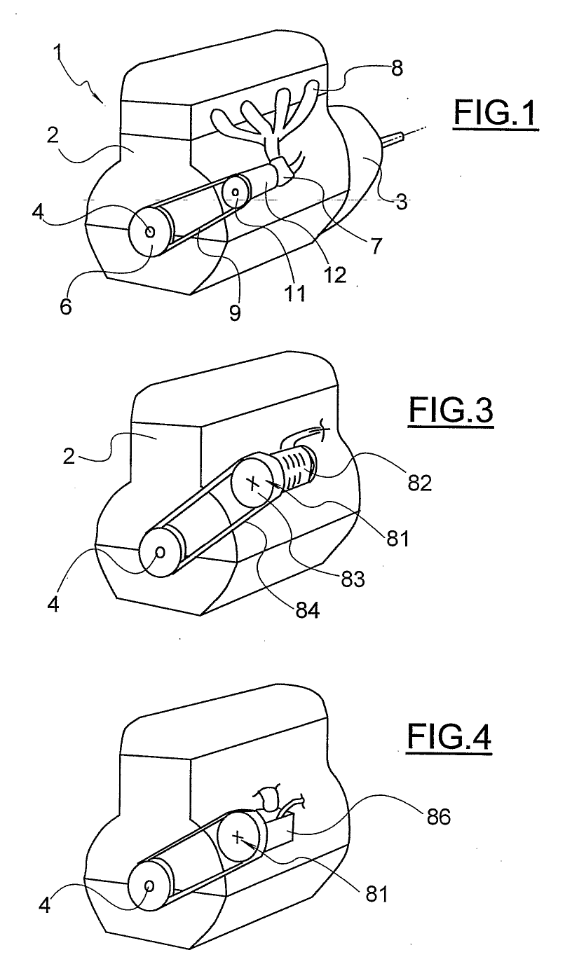

FIG. 1 is a diagrammatic perspective view of an engine according to the invention;

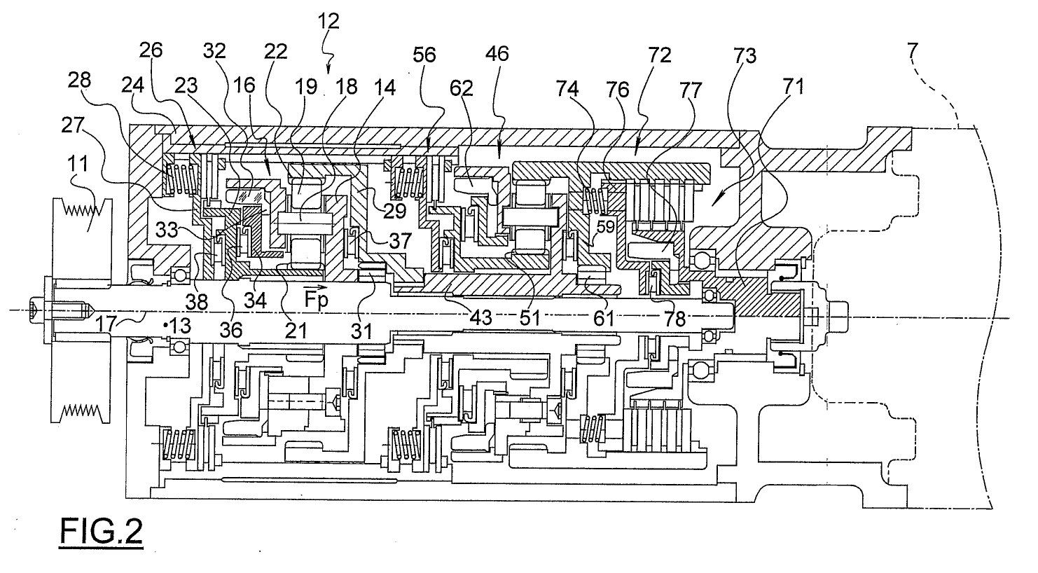

FIG. 2 is a view of the transmission device driving the compressor of the engine in FIG. 1, in axial section; and

FIGS. 3 and 4 are views similar to FIG. 1 but showing the use of the device according to the invention in driving an electric machine and an air-conditioning compressor, respectively.

In the example represented in FIG. 1, the supercharged heat engine 1 comprises a heat engine 2 typically of the type provided with pistons. The engine has an engine shaft one end of which, not shown, is connected to a gearbox 3 and the other end 4 carries at least one pulley 6 for driving accessories and auxiliary equipment. In the very simplified representation of FIG. 1, no accessory is shown, and one single piece of auxiliary equipment is represented, namely a supercharging compressor 7 which compresses the air sent into the intake manifold 8 of the engine 2. In practice, the air path between the compressor 7 and the manifold 8 can be more complicated than shown and travel in particular through an intercooler in order to rid the compressed air of the excess heat generated by the compression.

The compressor 7 is driven by a belt 9 linking the pulley 6 to a driven pulley 11. The pulley 11 drives the compressor 7 via a three-ratios transmission device 12 according to the invention.

The pulley 11 (FIG. 2) is keyed onto an input shaft 13 of the device, which is integral with a planet carrier 14 of a first differential mechanism 16 implemented as an epicyclic gear set. The planet carrier 14 has, positioned about the centreline 17 of the transmission device, trunnions 18 supporting freely rotatable planets 19. The planets 19 mesh on the one hand with a sun gear 21 of the mechanism 16, situated radially inside the planets, and on the other hand with a ring gear 22 located radially outside the planets. The sun gear 21 is integral with a disc 23 which can be selectively made integral with the case 24 of the transmission device by a selective coupling means implemented as a friction clutch 26. The clutch 26 comprises a clamping element 27 which is immobilized in rotation in relation to the case 24 and which is axially movable in relation to the case 24 under the thrust of a compression spring 28 which tends to clamp the clutch 26 and therefore to immobilize the sun gear 21 in relation to the case 24.

The ring gear 22 is integral with a bell-shaped element 29 which constitutes the output of a first module of the transmission device. This output is prevented from turning less quickly than the module input, constituted by the input shaft 13, by means of a free wheel 31 or one-way clutch, fitted between the shaft 13 and the bell-shaped element 29.

The planet carrier 14 drives in rotation centrifugal flyweights 32 which each carry a cam 33. When under the effect of centrifugal force the flyweights 32 pivot radially towards the outside, their cam 33 pivots in a clockwise direction in FIG. 2. This tends to push towards the left in FIG. 2, in relation to the planet carrier 14, a slider 34 driven in rotation by the planet carrier 14 and bearing against the disc 23, which is integral with the sun gear 21, by means of an axial thrust bearing 36.

The differential mechanism 16 has helical teeth. Consequently, the tooth pressure not only has a circumferential component allowing the transmission of the torque, but also an axial component which is opposed in the sun gear 21 and in the ring gear 22, whereas the planets 19 are subjected to mutually balancing forces. In the embodiment according to FIG. 2, the inclination of the teeth is chosen in relation to the direction of the engine torque to be transmitted in order for the sun gear 21 to be stressed axially in the direction of the arrow Fₚ which compresses the thrust bearing 36 and consequently tends to prevent the flyweights 32 from being lifted up. Consequently, the axial thrust in the ring gear 22 is directed towards the left of FIG. 2, and is absorbed by an axial thrust bearing 37 which by means of the bell-housing 29 bears against the planet carrier 14, which is integral with the shaft 13 held axially in its main bearings in relation to the case 24.

Moreover, on its side facing away from the thrust bearing 36, the disc 23 bears axially against the clamping element 27 via another axial thrust bearing 38.

The operation of the first module which has thus just been described is as follows.

At rest, the springs 28 clamp the clutch 26 in such a manner that the sun gear 21 is immobilized. When the rotation speed of the shaft 13 is low, the centrifugal force of the flyweights 32, which is proportional to the square of the rotation speed of the input shaft 13, is itself very low and consequently the flyweights 32 are prevented from being lifted up by the force of the springs 28 and by the axial teeth force Fₚ, which acts via the thrust bearing 36 and the slider 34. The module therefore starts with the sun gear 21 being stationary, so that the rotation of the planet carrier 14 with the input shaft 13 causes an increased rotation speed of the ring gear 22 and consequently of the output bell-shaped element 29. If the speed of the input shaft 13 reaches a certain top threshold which is all the more high as the torque to be transmitted, as measured by the axial force Fₚ, is high, the flyweights 32 tend to be lifted up while pushing the disc 23 towards the left against the force Fₚ. The disc 23 in its turn tends to push, via the thrust bearing 38, the clamping element 27 in the direction of release of the clutch 26 against the preloading springs 28. Consequently the clutch 26 begins to slide, the sun gear 21 is released, and begins to turn in the same direction as the planet carrier 14 and the bell-shaped element 29, whilst the rotation speed of the bell-shaped element 29 decreases. When this speed becomes equal to the speed of the input shaft 13, the free wheel 31 directly couples the input shaft 13 with the bell-shaped element 29. The torque is no longer transmitted by the differential mechanism 16, the tooth pressure and with it the axial force Fₚ disappear, whereby the flyweights 32 are now free positively to release the clutch 26 and the change in ratio which has just been carried out is established. The module has automatically shifted from an overdrive ratio to a direct drive ratio.

The return to the overdrive ratio takes place when the rotation speed drops below a bottom threshold, clearly below the top threshold having triggered the shift to direct drive. When the bottom threshold is reached, the preloading springs 28 have a force sufficient to push the clamping element 27 in the clamping direction of the clutch 26 against the centrifugally produced force generated by the flyweights 32.

The friction in the clutch 26 re-establishes a certain torque transmission via the teeth, then even the transmission of the entire torque when this friction is sufficient to slow down the sun gear 21 and consequently to accelerate the bell-shaped element 29 beyond the speed imposed by the free wheel 31. Consequently, the free wheel becomes inactive as regards the transmission of torque. The reappearance of a torque in the teeth 21 causes the reappearance of the axial force Fₚ which, by reducing or even eliminating the radial displacement of the flyweights 32 via the thrust bearing 36, at the same time helps the springs 28 to re-establish the conditions causing the mechanism 16 to operate in its overdrive ratio.

The bell-shaped element 29 is connected in rotation to a tubular shaft 43 mounted for free rotation about the input shaft 13, which extends through the whole device thereby to be an axial support for the device. The tubular shaft 43 is the input shaft of a second differential mechanism 46, which is thus mounted mechanically in series with the first mechanism 16. The second mechanism 46 is operatively identical to the first mechanism 16 and therefore will not be described again in detail. It is capable, like the mechanism 16 and under conditions which are similar in principle, of establishing either a direct drive ratio or an overdrive ratio between its input element 43 and an output bell-shaped element 59. In general, the numeric references used for this second mechanism 46 are increased by thirty in relation to those used for the homologous elements of the first mechanism 16. For the direct drive, the bell-shaped element 59 is coupled with the tubular input shaft 43 by a free wheel 61. For overdrive operation, a selective coupling means 56, constituted by a friction clutch, prevents the sun gear 51 from turning in relation to the case 24. The ratio of the number of teeth between the ring gear and the sun gear is closer to 1 in the mechanism 46 than in the mechanism 16. Thus, in the second mechanism 46 the jump between the two ratios is smaller.

The bell-shaped element 59 constituting the output element of the second module 46, is connected to an output shaft 71 of the transmission device 12 via a selective coupling means 72, constituted by a multi-disc clutch running in oil, forming part of a safety device 73 protecting the output shaft 71 and consequently the compressor 7 against overspeeds. The clutch 72 is normally clamped by compression springs 74 which preload the clutch. The springs 74 act via a clamping pusher 76 which can be pushed back in the release direction of the clutch 72, against the springs 74, by centrifugal flyweights 77 subjected to the rotation speed of the input shaft 71 and acting on the clamping element 76 via an axial thrust bearing 78. The axial thrust bearing 78 is necessary because the clamping element 76 turns with the bell-shaped element 59, therefore at a different speed from the output shaft 71 when the clutch 72 is released.

The overall operation of the transmission device of FIG. 2 is as follows.

At a low speed, the two differential mechanisms 16, 46, operate in overdrive. The speed of the input shaft 43 in the second mechanism, which turns with the flyweights 62 of this second mechanism, is therefore higher than that of the shaft 13 driving the flyweights 32 of the first mechanism. Consequently, when the rotation speed of the shaft 13 increases, it is firstly the flyweights 62 of the second mechanism 46 which cause the second mechanism 46 to shift to direct drive. If the speed of the input shaft 13 continues to increase, the first mechanism 16 in its turn shifts to direct drive.

There is therefore provided a transmission device which tends to regulate the operation speed of the compressor 7 in order to make it less dependent on the rotation speed of the engine shaft such that the compressor 7 operates as often as possible at its optimum speed and in particular with markedly improved effectiveness at low engine rotation speeds.

The selective coupling means 26, 56 are friction clutches running in oil, allowing a smooth change in gear ratios, without jerks.

The flyweights 32, 62 convert the centrifugal force into an axial force which is substantially proportional to the square of the rotation speed undergone by the flyweights. Thus it is certain that the increase in the centrifugally produced force is not totally counterbalanced by an increase in the resistant torque of the driven apparatus as a function of its rotation speed.

In the example in FIG. 3, a device 81 according to the invention is used in order to drive an electric machine 82 linked to the engine 2. The device 81 is a two-ratio device entirely accommodated inside a cup 83 which is integral with the input element of the transmission device. The periphery of the cup forms a pulley for the transmission belt 84 between this pulley and the shaft 4 of the engine 2. The electric machine can be a generator for recharging an accumulator battery, or also a generator with a starter function and/or with the function of an auxiliary driving machine adding its power to that of the engine 2. When the machine 82 operates as a motor, the tooth reaction such as Fₚ in FIG. 2 is reversed but by contrast the centrifugal force is relatively low so that the whole can be designed to enable overdrive operation (which is therefore a gear reduction operation when the machine 82 is regarded as a driver).

In the example represented in FIG. 4, a transmission device 81 analogous to that represented in FIG. 3 serves to drive an air-conditioning compressor 86. Here also, when the rotation speed of the shaft 4 of the engine becomes low, the device 81 shifts to overdrive ratio and increases the refrigerating power of the compressor 86.

Of course, the invention is not limited to the examples described and represented.

The invention is not limited to the establishment of overdrive and direct drive ratios.

1-21. (canceled)

22. A transmission device with at least two ratios for driving an apparatus (7, 82, 86) by a variable-speed engine (2), such as a vehicle engine, comprising a selective coupling means (26, 56) capable of two states corresponding to a low gear ratio and to a high gear ratio in which to apparatus is driven at a higher speed than in the low gear ratio for a same rotation speed of the engine, characterized in that said transmission device comprises at least one force-generating means (32, 62, 21, 51) for generating an actuating force that varies depending on at least one parameter chosen from a rotation speed and a torque in the device, and at least one urging means (34, 36, 23, 38) to apply the actuating force to the selective coupling means (25, 56).

23. A device according to claim 22, characterized in that said at least one force generating means comprises a centrifuge means (32, 62) and said at least one urging means applies the centrifugally produced force in the direction tending to put the selective coupling means (26, 56) in its state corresponding to a low transmission ratio.

24. A device according to claim 23, characterized in that the centrifuge means (32, 62) is subjected to a rotation speed at the input of a gear train (16, 46), producing one or the other of the two ratios depending on the state of the selective coupling means (26, 56).

25. A device according to claim 24, characterized in that said at least one force-generating means comprises a stabilizing means generating, from a transmitted torque which is modified by the state of the selective coupling means (26, 56), a state-stabilizing force (Fₚ) applied to the selective coupling means as an actuating force superimposed on the centrifugally produced force.

26. A device according to claim 24, characterized in that at least one force-generating means comprises a means (21, 51) generating an actuating force (Fₚ) from a transmitted torque.

27. A device according to claim 26, characterized in that said transmitted torque is that of an element (21, 51) which is differently loaded depending on whether the selective coupling means (26, 56) is in one or the other of its two states.

28. A device according to claim 27, characterized by comparison a differential mechanism (16, 46) which operates in direct drive in one of the two states of the selective coupling means (26, 56), wherein said transmitted torque is that of a transmission element (21, 51) which is short-circuited for torque transmission during direct drive operation.

29. A device according to claim 28, characterized in that the means generating an actuating force from a transmitted torque is a means of axial thrust (Fₚ) generated by the axial component of the pressure of helical teeth.

30. A device according to claim 29, characterized in that the low gear ratio is a direct drive ratio and the high gear ratio is an overdrive ratio.

31. A device according to claim 30, characterized in that the selective coupling means (26, 56) is a clutch for selective immobilization of a reaction element (21, 51) of a differential mechanism (16, 46).

32. A device according to claim 31 characterized in that said device comprises a one-way clutch (31, 61) preventing an output element (29, 59) from turning slower than an input element (13, 43) when the selective coupling means (26, 56) is in the disconnected status.

33. A device according to claim 31, characterized in that the selective coupling means (26, 56) is in the engaged state for operation in the high ratio, and, from the engaged state, when the torque to be transmitted exceeds a threshold, can allow a sliding until a one-way clutch re-establishes the low ratio.

34. A device according to claim 33, characterized in that a clamping element (27) of the selective coupling means is acted upon by a resultant of forces originating from:
at least one spring (26) tending to put the selective coupling means (28, 58) in the coupled state;
an element (34) subjected to a centrifugally produced force tending to put the selective coupling means (28, 58) in the uncoupled state;
an element (23) subjected to an axial thrust of helical teeth (Fₚ) promoting the coupled state.

35. A device according to claim 34, characterized in that the element (34) subjected to a centrifugally produced force bears onto the clamping element (27) by way of the element (23) subjected to an axial teeth-thrust.

36. A device according to one of claims 22 to 35, characterized by comprising two sub-assemblies (16, 46) each with two ratios, mounted in series.

37. A device according to claim 36, characterized by comprising at the output a safety clutch with centrifugal control (73) for declutching the output (71) of the device in case of an overspeed at the output.

38. A device according to claim 37, characterized by comprising an input element in the form of a pulley (83) forming a cup at least partially enclosing the device.

39. A use of the device according to claims 38 for driving an engine supercharging compressor (7).

40. A heat engine equipped with a supercharging compressor (7), characterized in that the supercharging compressor (7) is driven by the shaft (4) of the engine (2) via a transmission device (12) according to claim 38.

41. A use of the device according to claim 38 for driving a motor vehicle air-conditioning compressor (86) from the propulsion engine (2) of the motor vehicle.

42. A use of the device according to claim 38 for connecting an electric machine (82) to the propulsion engine (2) of the motor vehicle.
